(19) United States
(12) Patent Application Publication
(10) Pub. No.: US 2011/0194150 A1
(43) Pub. Date: Aug. 11, 2011

(54) METHOD FOR PRINTING IN MULTIPLE COLORS

(76) Inventor: Melissa Ward, Danville, IN (US)

(21) Appl. No.: 13/019,561

(22) Filed: Feb. 2, 2011

Related U.S. Application Data
(60) Provisional application No. 61/300,717, filed on Feb. 2, 2010.

(51) Int. Cl. G06K 15/02; G06F 17/00

(52) U.S. Cl. 358/2.1; 715/274

(57) ABSTRACT

A method of printing on a substrate includes enabling a user to draw a boundary of an area on an electronic page of text. The boundary has text characters both to the left of the boundary and to the right of the boundary on each of at least three vertically adjacent rows of the text. A user is enabled to indicate a first font color in which text within the area is to be printed, the first font color being different from a second font color in which text outside of the area is to be printed. The text within the area is printed in the first font color. The text outside the area is printed in the second font color.

### CROSS REFERENCES TO RELATED APPLICATIONS

The present application is a non-provisional of, and claims priority to, U.S. Provisional Patent Application No. 61/300,717, entitled “Stationary Software”, filed on Feb. 2, 2010, which is hereby incorporated by reference herein in its entirety.

### BACKGROUND OF THE INVENTION

It is known to print in multiple colors by selecting a block of highlighted characters and selecting a color in which the characters in the block are to be printed. A problem is that entire lines of printing are automatically included in the block, and it is not feasible to select only a portion of each line for printing in an alternative color. That is, for each individual line, the user would have to manually block out or select the characters in that particular line to be printed in an alternative color, which would be tedious and time consuming. Moreover, if text were to be later added to the document, the font color follows the originally selected characters, and thus any added text would destroy the pattern of colors that had originally been created.

### SUMMARY OF THE INVENTION

The present invention may be directed to a method of printing, either with an electric computer printer or by hand, with multiple colors, wherein the colors form a recognizable pattern on the printed paper. For example, the characters printed in red may form the shape of a heart or a cross on the printed paper, and may be surrounded by printed characters in another color, such as black. A line that delineates the border of the pattern of alternatively colored text may be drawn by the user by use of a computer mouse, for example. The pattern may form a design or shape.

### BRIEF DESCRIPTION OF THE DRAWINGS

The above-mentioned and other features and advantages of the invention will become more apparent to one with skill in the art upon examination of the following figures and detailed description. The components in the figures are not necessarily to scale, emphasis instead being placed upon illustrating the principles of the invention. Moreover, in the figures, like reference numerals designate corresponding parts throughout the different views.

FIG. 1 is a plan view of one embodiment of a front paper sheet of an apparatus of the present invention.

FIG. 2 is a plan view of one embodiment of another sheet of the apparatus of FIG. 1.

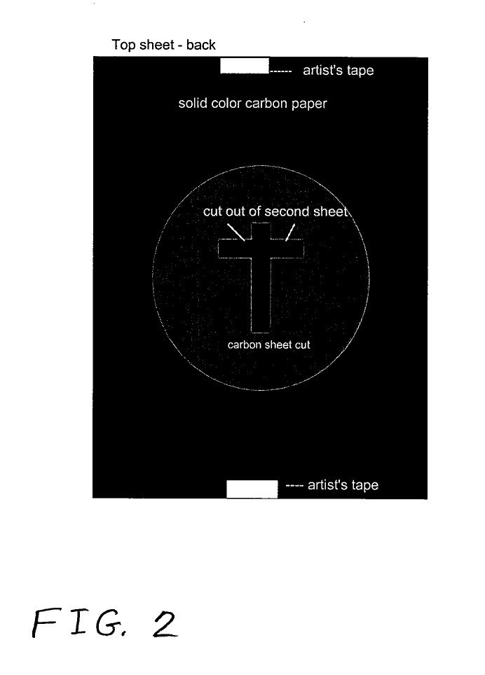

FIG. 3 is a plan view of one embodiment of yet another sheet of the apparatus of FIG. 1.

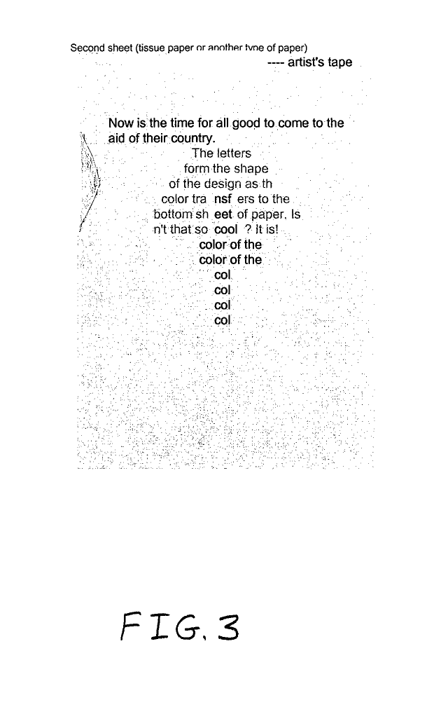

FIG. 4 is a plan view of a page printed in accordance with one embodiment of the present invention.

FIG. 5 is another plan view of a page printed in accordance with one embodiment of the present invention.

FIG. 6 is yet another plan view of a page printed in accordance with one embodiment of the present invention.

FIG. 7 is a plan view of the text of the printed page of FIG. 5 as displayed on a computer monitor with an outline of the heart-shaped pattern having been drawn on the display by use of software of the invention in conjunction with a computer mouse.

FIG. 8 is a plan view of the text of the printed page of FIG. 6 as displayed on a computer monitor with an outline of the heart-shaped pattern having been drawn on the display by use of software of the invention in conjunction with a computer mouse.

FIG. 9 is a plan view of a page of electronic text as displayed on a computer monitor with a partial outline of the parallelogram pattern having been drawn on the display by use of software of the invention in conjunction with a computer mouse.

FIG. 10 is a plan view of another page of electronic text as displayed on a computer monitor with a partial outline of the parallelogram pattern having been drawn on the display by use of software of the invention in conjunction with a computer mouse.

FIG. 11 is a plan view of yet another page of electronic text as displayed on a computer monitor with a partial outline of the parallelogram pattern having been drawn on the display by use of software of the invention in conjunction with a computer mouse.

### DETAILED DESCRIPTION OF THE PRESENTLY PREFERRED EMBODIMENTS

The invention is described herein as specific embodiments to clearly articulate the invention to one skilled in the existing net art and supporting art of advertising. Additionally, the invention may be implemented and applied using modifications without departing from the spirit and overall scope of the invention.

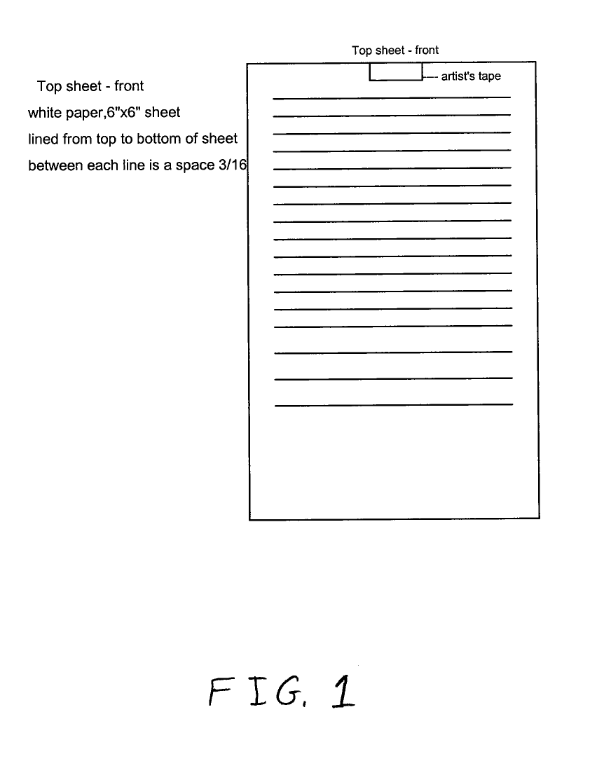

Referring to FIG. 1, there is shown one embodiment of an apparatus of the present invention for typing or handwriting in multiple colors. As the user types or handwrites across the page, the letters change colors automatically as the typing/handwriting enters a picture region. There are different background colors to choose from and different colors for each of the pictures. For instance, black background with yellow face could alternatively be yellow background with black face or white background with black face.

The invention may be in the form of software. However, in paper form, the invention may include carbon (or carbonated) paper on the backside of the design and a blank page attached which will have the end result. Paper with a blank page may be attached underneath.

The paper may include lined paper on top. On the bottom side of the paper may be a sheet of carbon paper. The carbon paper may be cut into a design such that, when the user writes on the blank page, the writing transfers or comes out on the bottom sheet, that is attached, to form the design. The bottom sheet may be strong tissue paper or regular typing paper.

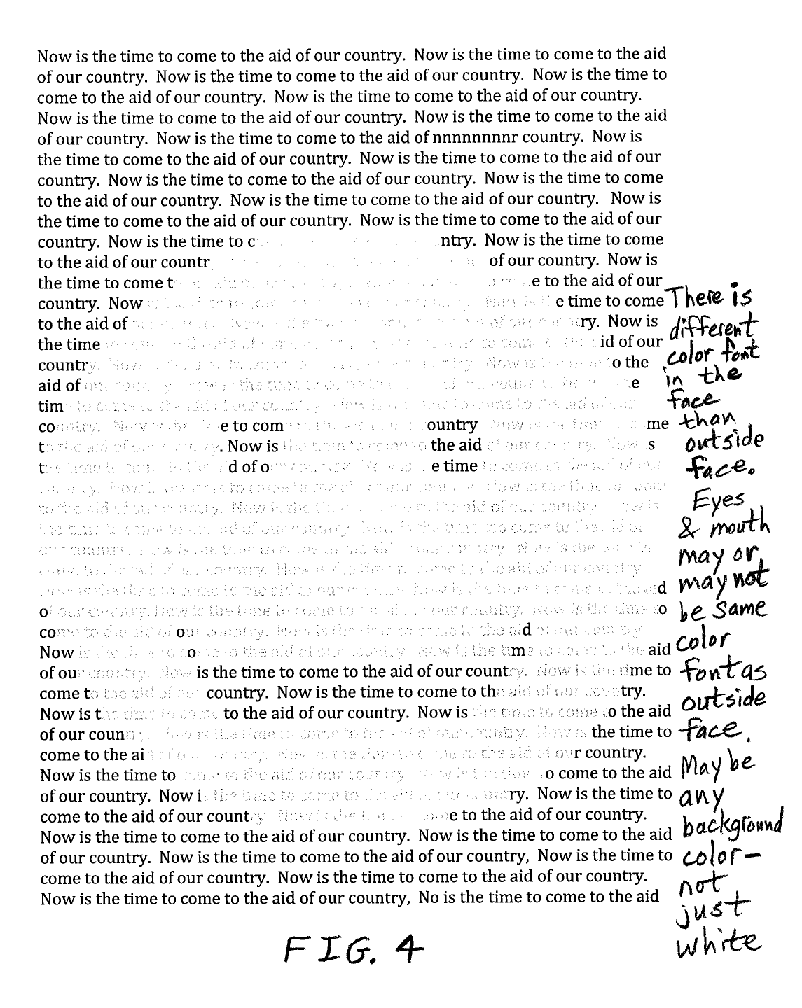

FIG. 4 is a plan view of a page printed in accordance with one embodiment of the present invention. After entering the text into the document, with the text of the document being displayed on a computer monitor, the user may use the computer mouse to draw the “smiley face” pattern over the text shown in FIG. 4. The software may enable the user to draw freehand and/or draw straight lines and curves, with the user designating the end points of the lines and/or curves. More particularly, the user may use the mouse to draw the circle that defines the outer boundary of the face and that extends entirely from the left-hand edge of the text to the right-hand edge of the text. The user may also draw a smaller circular shape surround “e to com” on one line, “Now is” on the next line, and “d of o” on the third line to form the boundary of one of the eyes of the smiley face. The user may draw another smaller circular shape to form the other eye of the smiley face. The user may also draw two arcuate curves that intersect at their endpoints to thereby define the boundaries of the mouth of the smiley face. The user may select the colors of printing outside the face, within the face, within the two eyes, and within the mouth. For example, the print font outside the face may be black, the print font within the face may be yellow, the print font within the eyes may be blue, and the print font within the mouth may be red. In general, there is different color font within the face than outside the face. The eyes and mouth may or may not be the same color font as outside the face.

It may also be possible for the user to specify another background color other than white within the face and between the actual characters within the face. For example, the text characters within the face may be green, as selected by the user, and the space between the characters (on which no toner or ink is otherwise deposited) may be designated as yellow by the user. Thus, as possibly constrained by the capabilities of the printer, yellow ink or toner may be deposited on, and may partially or completely fill, the spaces between the text characters within the face.

Although the invention is described primarily as being applied to printing on paper, it is to be understood that embodiments of the invention may equally be applied to display of text on a monitor or computer screen. For example, the user may create a text document such as an electronic greeting card, and may designate or choose the colors of the font to form pictures or patterns. The choice of a background color to be used as background between the text characters may be especially applicable to electronic documents displayed on a monitor or computer display screen.

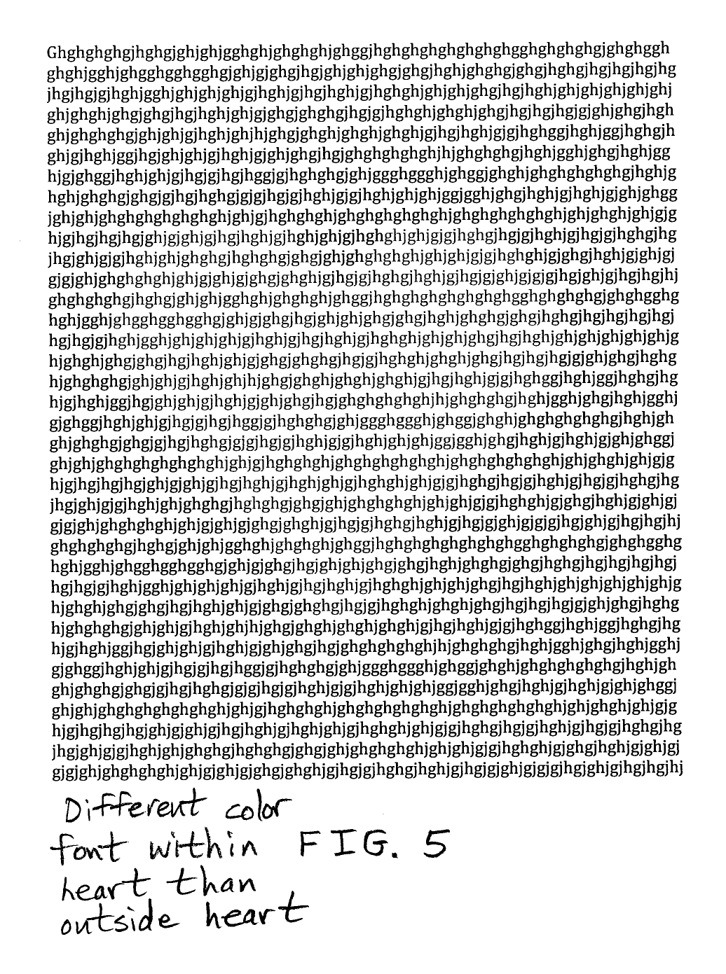

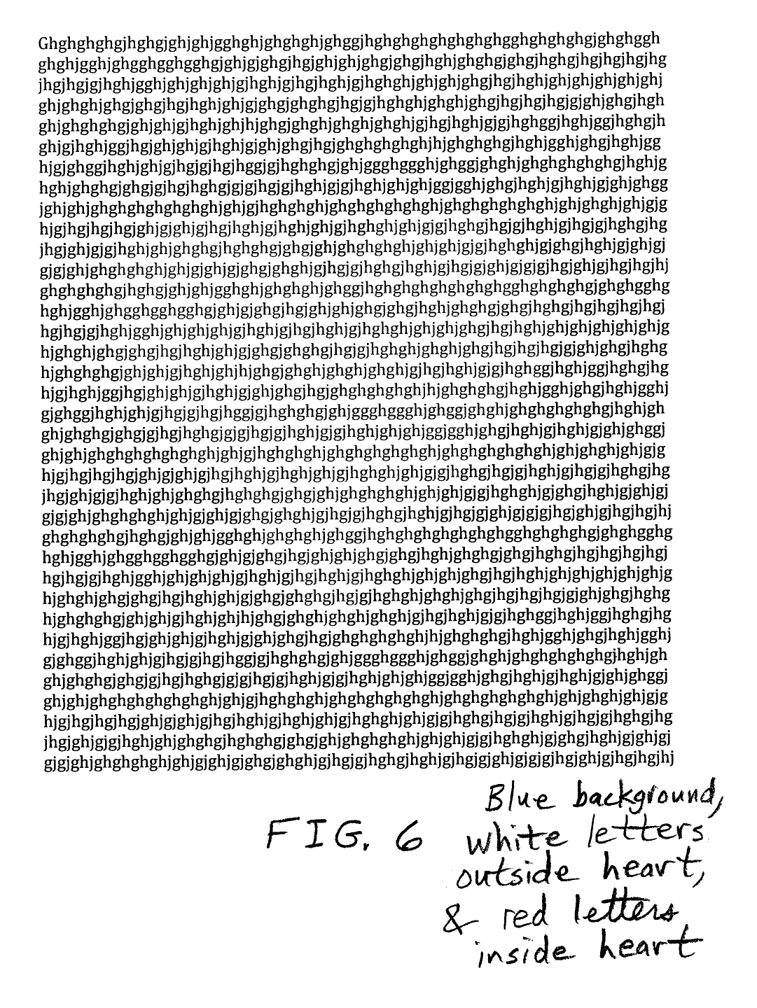

Two versions of a heart pattern are illustrated in FIGS. 5 and 6. The printed pattern of FIG. 5 has a white background with black type font except within the heart, wherein there exists red type font with a white background. Thus, there is a different color font within the heart than outside the heart. The printed pattern of FIG. 6 has a blue background with white type font except within the heart, wherein red type font exists on a white background. That is, it is possible for the user to select a white font on a colored background outside the pattern and/or inside the pattern.

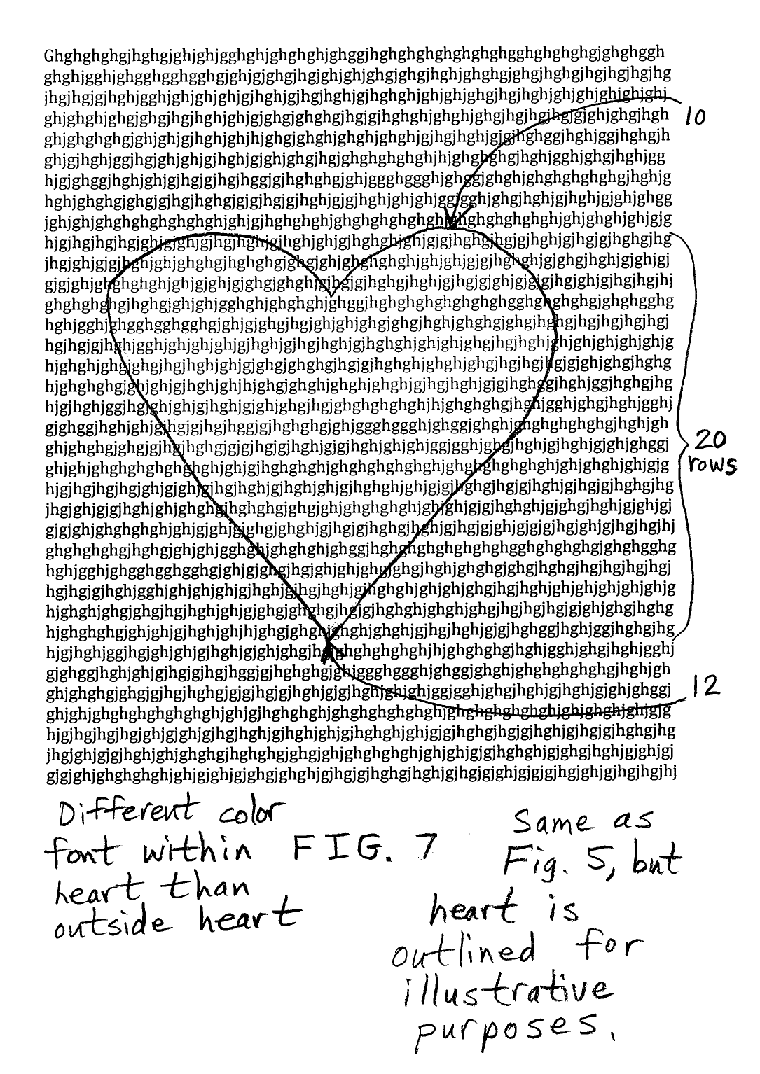

FIG. 7 is a plan view of the text of the printed page of FIG. 5 as displayed on a computer monitor with an outline of the heart-shaped pattern having been drawn on the display by use of software of the invention in conjunction with a computer mouse. After the user has drawn the pattern as shown in FIG. 7, and has selected a font color, and possibly a background color, within the heart boundary, and possibly has selected another font color, and possibly a background color, outside of the heart boundary, then the selected colors may be implemented. The colors may be implemented automatically upon completion of the above steps, or the user may initiate the implementation of the colors. The colors may be implemented on a monitor screen and/or on a printed page.

As shown in FIG. 7, the inventive method may include enabling a user to draw a boundary of an area on an electronic page of text such that the boundary has text characters both to the left of the boundary and to the right of the boundary on each of at least three vertically adjacent rows of the text. In the specific example of FIG. 7, a boundary line, or a portion of a boundary line, extends between points 10 and 12. This boundary line, or portion of a boundary line, has text characters both to the left of the boundary and to the right of the boundary on each of twenty vertically adjacent rows of the text.

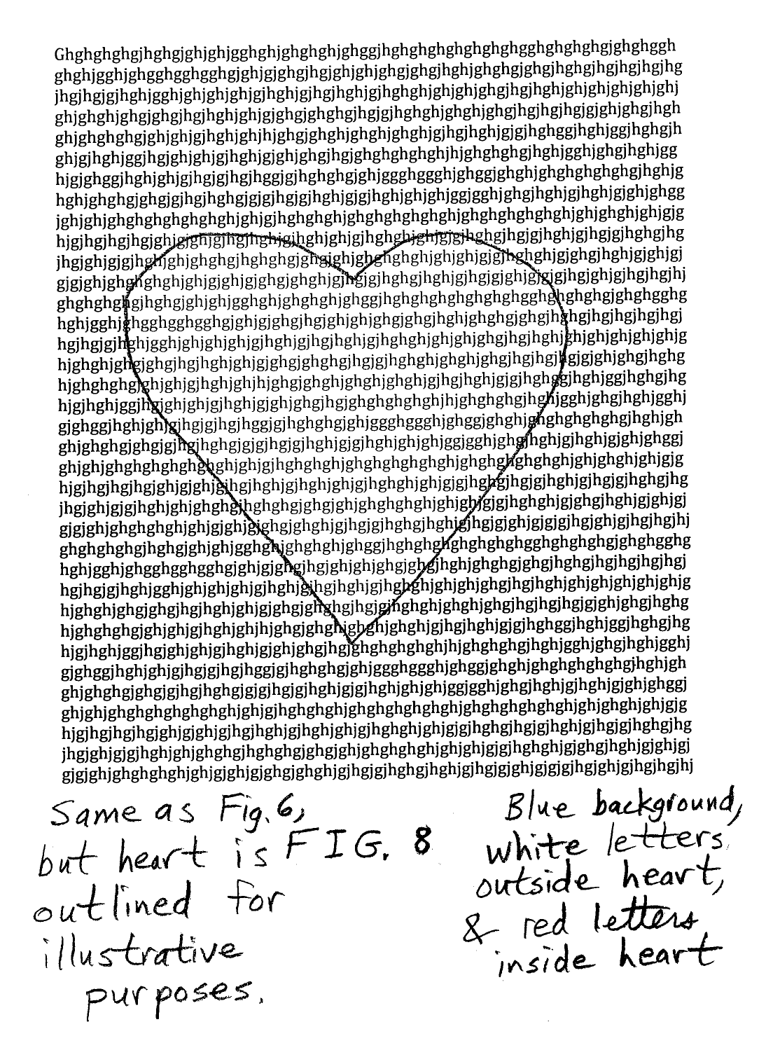

FIG. 8 is a plan view of the text of the printed page of FIG. 6 as displayed on a computer monitor with an outline of the heart-shaped pattern having been drawn on the display by use of software of the invention in conjunction with a computer mouse. After the user has drawn the pattern as shown in FIG. 8, and has selected a font color, and possibly a background color, within the heart boundary, and possibly has selected another font color, and possibly a background color, outside of the heart boundary, then the selected colors may be implemented. The colors may be implemented automatically upon completion of the above steps, or the user may initiate the implementation of the colors. The colors may be implemented on a monitor screen and/or on a printed page.

In the above embodiments, the user draws a closed-loop shape, such as a circle, a mouth shape, or a heart. However, it is to be understood that a user can select an area within “closing the loop.” For example, if a user draws three sides of a four-sided shape, such as a rectangle, then the software may complete the shape by adding the fourth side and changing the color within the area defined by the four sides.

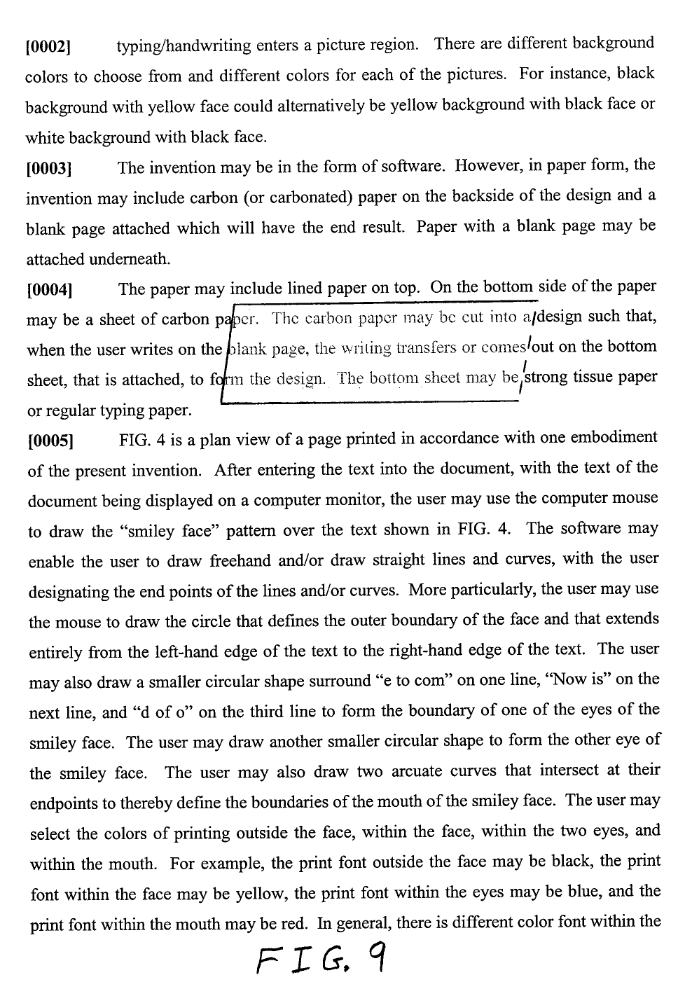

As a specific example, FIG. 9 is a plan view of a page of electronic text as displayed on a computer monitor with a partial outline of the parallelogram pattern having been drawn in three solid line segments on the display by use of software of the invention in conjunction with a computer mouse. The software automatically adds the fourth line segment, shown in a dashed line segment, to complete the parallelogram.

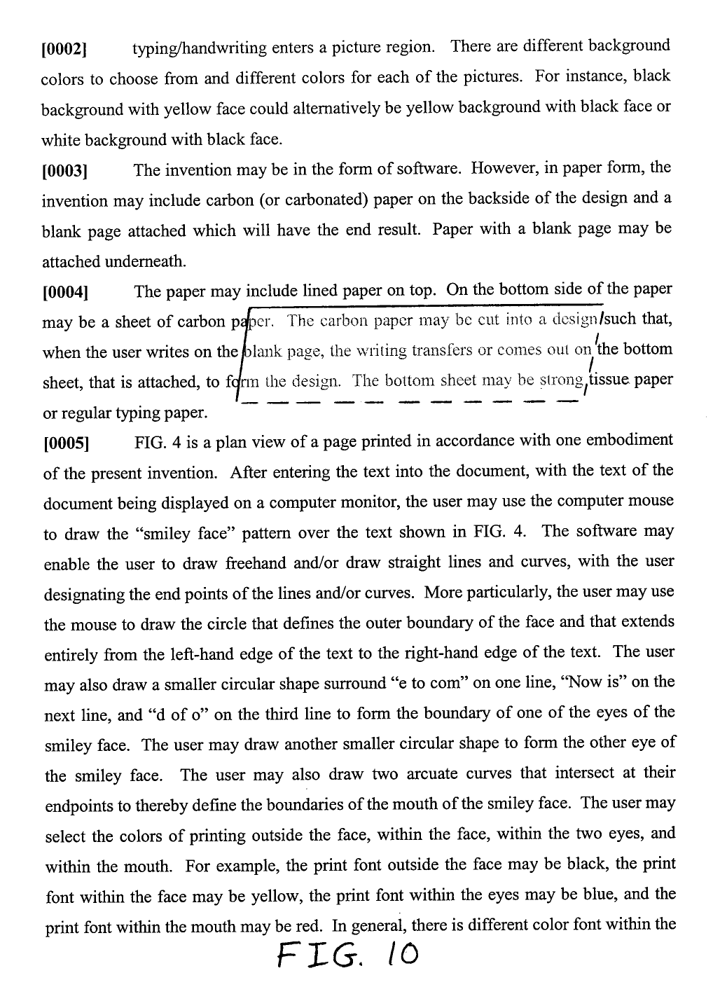

FIG. 10 is a plan view of another page of electronic text as displayed on a computer monitor with a partial outline of the parallelogram pattern having been drawn in two solid line segments on the display by use of software of the invention in conjunction with a computer mouse. The software automatically adds the third and fourth line segments, shown in two dashed line segments, to complete the parallelogram.

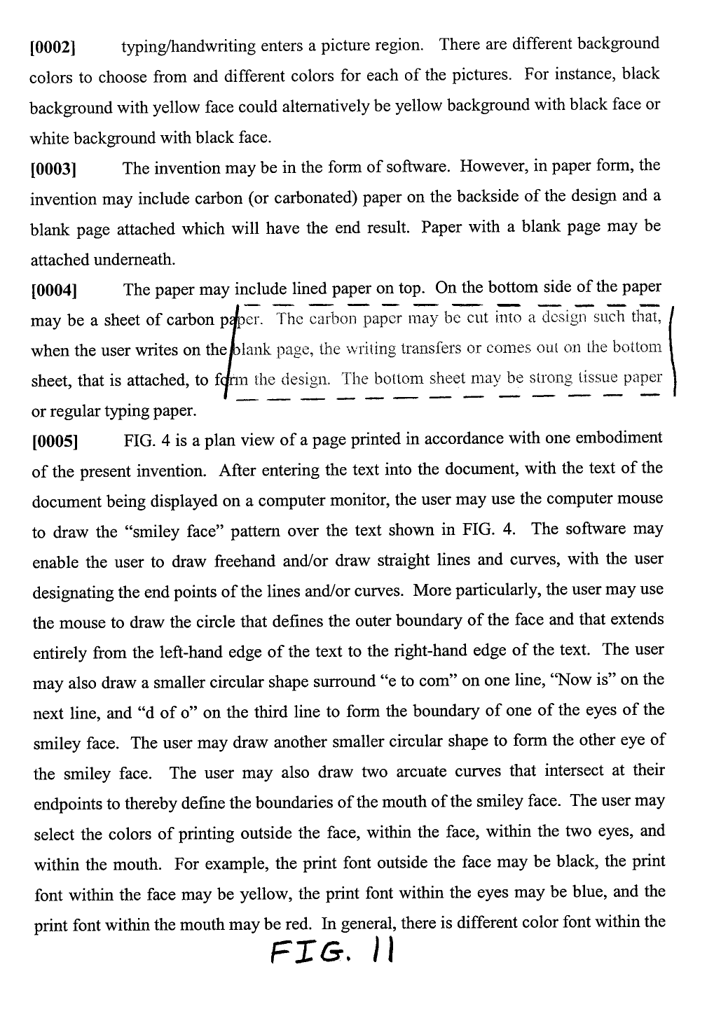

FIG. 11 is a plan view of yet another page of electronic text as displayed on a computer monitor with a partial outline of the parallelogram pattern having been drawn in two solid line segments on the display by use of software of the invention in conjunction with a computer mouse. As shown in FIG. 11, the rightmost one of the two line segments is not straight, even to the naked eye, but the software automatically adds third and fourth line segments, shown in two dashed line segments, to complete the shape within which the user selects an alternative font color.

The user may partially or completely overlap shapes on top of each other, with the font color of the most recently drawn shape being the effective font color in the overlapped area. Alternatively, the font colors associated with the overlapped shapes may be “mixed together” to create another color in the overlapped area. For example, the overlapping of a red area with a blue area may result in a purple overlapped area.

As described hereinabove in the Background section, it is known in the prior art to select a block of text (the block extending entirely across the page in-between the first and last rows, if more than two rows are selected), for printing in another color. Thus, it is well within the capability of one skilled in the art to implement the methods of the present invention in word processing software, and it is not necessary for such details to be entirely provided herein.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method of printing on a substrate, comprising the steps of:
enabling a user to draw a boundary of an area on an electronic page of text, the boundary having text characters both to the left of the boundary and to the right of the boundary on each of at least three vertically adjacent rows of the text;
enabling a user to indicate a first font color in which text within the area is to be printed, the first font color being different from a second font color in which text outside of the area is to be printed;
printing the text within the area in the first font color; and
printing the text outside the area in the second font color.

2. A method of displaying text on an electronic screen, comprising the steps of:
enabling a user to draw a boundary of an area on an electronic page of text, the boundary having text characters both to the left of the boundary and to the right of the boundary on each of at least three vertically adjacent rows of the text;
enabling a user to indicate a first font color in which text within the area is to be displayed, the first font color being different from a second font color in which text outside of the area is to be displayed;
displaying the text within the area in the first font color; and
displaying the text outside the area in the second font color.
